(19) United States
(12) Patent Application Publication
(10) Pub. No.: US 2016/0352508 A1
(43) Pub. Date: Dec. 1, 2016

(54) Methods and Apparatus for Plaintext Analysis as Countermeasures Against Side Channel Attacks

(71) Applicant: Texas Instruments Deutschland, GMBH, Freising (DE)

(72) Inventors: Oscar Miguel Guillen-Hernandez, Munich (DE); Ralf Brederlow, Poing (DE)

(73) Assignee: Texas Instruments Deutschland GMBH, Freising (DE)

(21) Appl. No.: 14/531,243

(22) Filed: Nov. 3, 2014

Related U.S. Application Data
(60) Provisional application No. 62/012,578, filed on Jun. 16, 2014.

(51) Int. Cl. H04L 9/00

(52) U.S. Cl. CPC H04L 9/003

(57) ABSTRACT

Plaintext analysis as a countermeasure against side channel attacks. A system is disclosed that includes an encryption/decryption module performing an encryption algorithm for encrypting plaintext data using a secure encryption key stored in non-volatile memory coupled to the encryption/decryption module, the encryption/decryption module further performing an algorithm for decrypting encrypted ciphertext using the secure encryption key; and a plaintext analysis module coupled to the plaintext data, the plaintext analysis module performing an analysis and determining whether the plaintext data correlates to expected plaintext data, the plaintext analysis module outputting a signal indicating a side channel attack, responsive to the determining. Additional methods and apparatus are disclosed.

### RELATED APPLICATIONS

This patent application claims priority to U.S. Provisional Application Ser. No. 62/012,578, filed Jun. 16, 2014, entitled “PLAINTEXT ANALYSIS AS COUNTERMEASURE AGAINST SIDE-CHANNEL ATTACKS” which is hereby incorporated by reference herein in its entirety.

### TECHNICAL FIELD

The embodiments relate generally to plaintext analysis in secure systems using encryption to detect, react to and/or interdict side channel attacks.

### BACKGROUND

In a side channel attack against a secure system using encryption, attackers use measurements of physical characteristics while the secure system is performing encryption and decryption to try and determine the value of the secret encryption codes, which are typically a data string that is referred to as a secret key. By sending plaintext data for encryption, or by sending ciphertext for decryption, into the encryption and the decryption portions of the secure system, and by then observing the physical characteristics of the system during the encryption and decryption processing, the attacker attempts to infer the value of the secret key. An attacker that obtains the secret key can then easily access the encrypted data in other similar systems that use the same secret key for the encryption algorithm.

Secure devices include modules which use encryption. These modules are incorporated into devices that are physically available to the attacker. Examples include smart cards, chip-and-PIN credit cards, RFID tags, secure USB dongles, cell-phones, portable computers, tablet computers, non-volatile memory cards with encryption for data storage, and the like. Because the attacker has physical control of the secure devices, the attacker can probe the physical systems of these secure devices during encryption and decryption processing. The attacker can also manually insert plaintext data or ciphertext data into the system to force the encryption or decryption block to operate on data provided by the attacker. In this manner it is possible for the attacker to detect information leakage from the encryption system. The leakage patterns can be analyzed to determine a secret code or encryption key. The side channel attacker may measure power consumption and power changes such as by observing current spikes, electromagnetic emissions, the time a particular process takes to complete, and the like, while submitting plaintext data to the system for encryption, or while submitting ciphertext to the system for decryption. Because the attacker has physical access to the secure device, the attacker may repeatedly submit numerous examples of varying data patterns to the encryption/decryption module and make repeated measurements of the leaked physical information. The attack can continue until the information obtained by the attacker is sufficient to infer or determine the secret key.

In the known prior solutions, side channel attack countermeasures typically involve attempting to physically shield or cover the physical leakage, such as by using shielding against EM emissions, for example. Physical shielding techniques can eventually be overcome by an attacker, because the secure system including the encryption is physically in the possession of the attacker.

In another prior known solution, masking can be performed. In side channel attack terminology, masking refers to a process in which the intermediate values of the transformations performed during encryption are randomized. Random intermediate values will have a power profile which is independent to the real intermediate values. The masking process involves adding the random “masks” at the beginning of an encryption/decryption routine, performing the computations on the masked internal values and finally removing the resulting “masks” in the end in order to deliver the expected encrypted or decrypted values. Thus, the encryption/decryption is modified by adding random information such as random or dummy processing steps to the encryption or by adding dummy data to the plaintext data or ciphertext. Masking is used to further frustrate attempts to infer secret information from information leakage during the processing. However, adding randomness to the encryption/decryption requires modification to the encryption system, and necessarily adds inefficiency to the encryption algorithm.

In another prior known solution, a technique referred to as “hiding” is used. The concept of hiding is to minimize the information that the attacker will get when the physical phenomena of a device is measured. Hiding can be done by reducing the signal of interest or by increasing the noise of the device. Reducing the signal is done usually by making use of balanced operations or logic (i.e. electronic gates that consume the same power independent of the values processed by them). Increasing the noise can be done in the time or in the amplitude axis. In the time axis, random or dummy processing steps are added to modify when the actual computation occurs. In the amplitude axis, random or dummy processing steps are performed in parallel to the cryptographic operation in order to try to hide the influence of the computations on secret data on the physical phenomena. Each approach requires adding logic or adding software steps, or both, to the computation used for the encryption/decryption algorithm.

Improvements in countermeasures against side channel attacks are therefore needed to address the deficiencies and the disadvantages of the known prior approaches. Solutions are needed that are robust, are independent of the encryption/decryption algorithm, and that are easy to implement with both existing and new systems at relatively low cost.

### SUMMARY

Aspects of the present application provide countermeasures to side channel attacks that are improvements over the prior known solutions and which extend the available solutions. In an aspect of the present application, a novel plaintext analysis approach is used. A plaintext data analysis module that is independent of the encryption receives the plaintext that is input to, or output from, an encryption/decryption module. An analysis is performed on the plaintext data. Various characteristics can be examined to determine if the plaintext data is consistent with a normal or expected data pattern, or if it is more likely that the plaintext data or ciphertext is being used in (or is the result of) a side channel attack. In response to detection of a side channel attack, the system can then take actions such as resetting, shutting down, reporting the problem, or halting for a time sufficient to prevent or interdict the side channel attack. In various aspects of the present application, detection and interdiction of the side channel attacks are performed. The use of the novel aspects of the present application helps protect an encryption/decryption system better than prior known prevention approaches, by actively stopping an attacker from attempting to obtain more information through repeated attacks, unlike the known solutions.

In one aspect of the present application, a system including countermeasures for side channel attacks includes an encryption/decryption module coupled to receive plaintext data for encryption and outputting corresponding ciphertext, and further coupled to receive ciphertext for decryption and outputting corresponding plaintext data, the encryption/decryption module performing an encryption algorithm using a secure encryption key stored in non-volatile memory, the encryption/decryption module further performing an algorithm for decrypting encrypted ciphertext using the secure encryption key; and a plaintext analysis module coupled to the plaintext data received by the encryption/decryption module for encryption and further coupled to the plaintext data output from the encryption/decryption module after decryption, the plaintext analysis module performing an analysis on the plaintext data and determining whether the plaintext data correlates to expected plaintext data, the plaintext analysis module further having an output for outputting a signal indicating a side channel attack, responsive to the determining.

In another aspect of the present application, a method for providing side channel attack countermeasures includes in a secure encryption/decryption module, performing data encryption on plaintext data using a stored secure encryption key and outputting ciphertext corresponding to the plaintext data, and further performing a data decryption on ciphertext using the stored secure encryption key, and outputting plaintext data corresponding to the ciphertext; performing analysis on the plaintext data in a plaintext data analysis module coupled to receive the plaintext data, and determining whether the plaintext data corresponds to plaintext data within an expected plaintext data set; and performing an action to interdict a side channel attack responsive to the determining.

In a further aspect of the present application, a tangible non-volatile computer readable media storing non-transitory instructions for a processor which, when retrieved and executed by the processor, cause the processor to perform encrypting received plaintext data into ciphertext by performing an encryption algorithm and using a secure encryption key stored in a non-volatile memory; and performing a plaintext analysis to determine whether the plaintext data corresponds to a set of expected plaintext data, and signaling a side channel attack is detected, responsive to the determining.

Previously, countermeasures against side channel attacks required either physical modification to a system, or modification of an encryption algorithm. Recognition in the present application that the use of plaintext analysis in an independent, orthogonal data analysis approach can detect side channel attacks as they occur, without the need for modifying existing encryption/decryption modules, and while still achieving robust detection and providing interdiction of the side channel attacks, advantageously increases the security of user data and reliability of secure systems in a variety of applications. Further the plaintext analysis aspects of the present application are independent of the existing encryption and decryption modules and may be added to existing systems with slight modifications and without modifying the encryption algorithms used, and without modifying the implementations used for the encryption/decryption, and the plaintext analysis as countermeasures can be used in addition to other side channel attack countermeasures, to further enhance robustness of secure systems.

### BRIEF DESCRIPTION OF THE DRAWINGS

For a more complete understanding of the illustrative embodiments described herein and the advantages thereof, reference is now made to the following descriptions taken in conjunction with the accompanying drawings that are incorporated in and which are part of this specification, in which:

FIG. 1 illustrates in a block diagram an example microprocessor system for use with the embodiments;

FIG. 2 illustrates in a block diagram an example system using a microprocessor for illustrating an application of the embodiments;

FIG. 3 illustrates in a block diagram another application for use with the embodiments;

FIG. 4 illustrates in a simplified block diagram an illustrative embodiment including an plaintext analysis module performing encryption;

FIG. 5 illustrates in a simplified block diagram an illustrative embodiment performing decryption;

FIG. 6 illustrates in a simplified block diagram an illustrative example implementation of the plaintext analysis function of an embodiment; and

FIG. 7 illustrates in a flow chart a method embodiment.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION

The making and using of example illustrative embodiments are discussed in detail below. It should be appreciated, however, that the embodiments contemplated as part this application provide many applicable inventive concepts that can be embodied in a wide variety of specific contexts. The specific embodiments discussed are merely illustrative of specific ways to make and use the various embodiments, and the examples described are not to be read so as to limit either the scope of the specification, or the scope of the appended claims.

For example, when the term “coupled” is used herein to describe the relationships between elements, the term as used in the specification and the appended claims is to be interpreted broadly, and is not to be limited to “connected” or “directly connected” but instead the term “coupled” may include connections made with intervening elements, and additional elements and various connections may be used between any elements that are “coupled.”

For purposes of this application, “plaintext” is any unencrypted information. The information can be any data, including as non-limiting examples executable instructions such as micro-code, packet header data, confidential information such as account numbers, pin codes, and the like, or any other unencrypted data where encryption is desired. Similarly “ciphertext” includes any form of encrypted data. The ciphertext can include, as non-limiting examples, encrypted executable instructions, such as micro-code, encrypted packet header data, encrypted confidential information such as customer identification codes, account numbers, and the like.

The modules for security encryption and decryption, the cryptographic algorithms, and the plaintext analysis modules described for use in the embodiments below can be implemented as dedicated hardware, programmable hardware, software, firmware, state machines, look-up tables, or logic arrays. Combinations of hardware and software can be used to implement these functions.

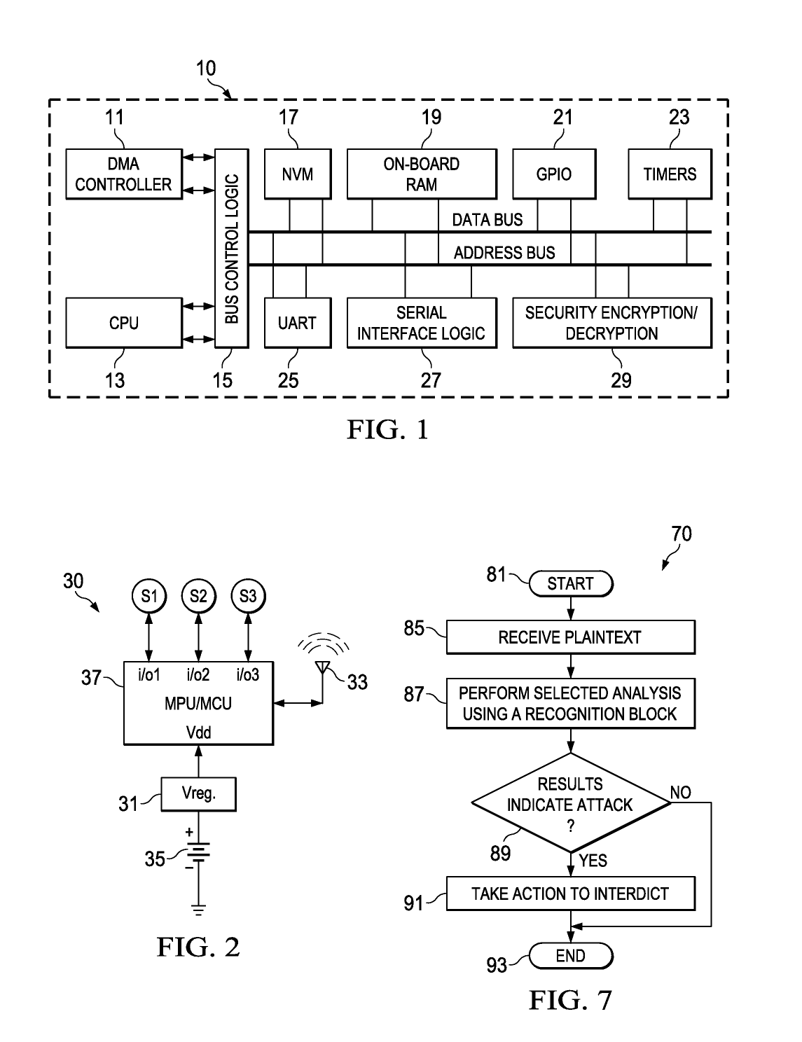

In FIG. 1, a microprocessor unit (MPU) 10 is shown in a simple block diagram to illustrate an example application for the embodiments. The MPU 10 may be for example a microprocessor, microcontroller, mixed signal processor, digital signal processor, RISC (reduced instruction set computer) core, ARM (advanced RISC machine) or the like.

In general the MPU 10 can be a programmable processing device. In the MPU 10, a shared data bus and an address bus are used to couple various functional blocks. Central processing unit 13 may be a RISC, CISC, ARM or other processing unit for performing operations in response to retrieved instructions such as micro-code. Direct memory access (DMA) controller 11 couples the MPU 10 to external memory devices such as DRAM devices (not shown). On board data storage and code storage are provided by both non-volatile memory such as NVM 10, and by dynamic memory such as on-board RAM 19. NVM 10 may be, for example, FLASH memory, EEPROM, EAROM, EPROM or similar non-volatile memory for data storage, or increasingly, NVM 10 can be ferroelectric RAM or FRAM. FRAM is a non-volatile on-board memory technology which offers the write speed and access times comparable to DRAM memory devices, but which is non-volatile (that is, the stored data remains stored and available for later use without continuous power supplied to the device). FRAM reliably stores data with a lifetime and with many robust write and read cycles comparable to similar FLASH devices. In addition, the access in FRAM blocks is word or byte addressable, while in contrast, in FLASH devices sector access is used. For example in a FLASH device, data writes require accessing an entire sector at a time, changing the affected bits, and then writing the sector back to the FLASH memory.

On-board RAM 19 may be dynamic RAM, but for simplicity of operation and for ease of manufacture SRAM memory is more often used, even though the area needed for the SRAM cells is substantially larger than that required by corresponding DRAM cells.

Input/output operations to MPU 10 can be performed, for example, by a general purpose I/O block GPIO 21, which allows transmitting and receiving data from external devices such as sensors. Timing operations are supported by a plurality of timers 23. Additional communication blocks such as a universal asynchronous receiver transmitter (UART) 25 and serial interface logic block 27 allow for communications over modem devices, or using serial bus interfaces such as 12C, SPI, JTAG and the like. The various blocks in MPU 10 are illustrative examples and many other functions can be included, for example analog to digital converters (ADC), digital to analog converters (DAC), multipliers, co-processors and the like may be included or added to form a mixed signal processor as MPU 10.

In the MPU 10, the Security Encryption/Decryption block 29 provides the encryption of data which results in encrypted data, or ciphertext, which can then be stored. The encrypted data can also be retrieved from storage and decrypted to provide the plaintext data. The encryption block 29 employs an encryption algorithm using a secure encryption key that is provided at the factory or in the initial configuration of the MPU 10 and stored in a permanent non-volatile memory on the MPU 10. The encryption used can be, for example, a standard encryption algorithm such as the Data Encryption Standard (DES), the triple DES standard (Triple DES), the Advanced Encryption Standard (AES) or other like encryption schemes. The secret key may be a very long data string that is supplied by the manufacturer of the MPU 10 and stored within the MPU 10, and the secret key may also be encoded or encrypted. The secret key may be 64, 128 or 256 bits long or longer to make discovery of or decoding the secret key very difficult and preferably impossible. The length of the key depends on the particular encryption algorithm being used. The length of the longer length keys is intended to keep an attacker from succeeding in obtaining the values of the key through repeated guessing of all possible combinations, a “brute force” attack. However, in known prior solutions attackers have been able to discover the secret keys in some prior secure devices.

In an example encryption application where the embodiments can be used, when using a programmable integrated circuit or system such as MPU 10 to design and build a proprietary system, a user will write instructions to cause the MPU to perform tasks associated with a particular application. These proprietary user instructions may include specially developed code such as algorithms, signal or data filters, efficient coding schemes, calculation methods and the like that are valuable and secret intellectual property owned by the user. The confidential code enables the user to program MPU 10 to perform a particular task as part of the production of an overall system tailored to a particular application. In order to protect the proprietary instructions which may be in the form of code or microcode, for example, that a user develops, the code is encrypted by block 29 before it is stored in non-volatile memory such as NVM 17. When the encrypted micro-code is later retrieved for execution by the CPU 13, the micro-code is decrypted by the security block 29 before execution by the CPU 13.

FIG. 2 further illustrates an example system 30 where the embodiments can be used. In FIG. 2, an MPU/MCU 37 which can be a microprocessor unit similar to the MPU 10 of FIG. 1 is shown in an application system. In an example application, MPU/MCU integrated circuit 37 has additional functions added on board to form a system on a chip (SOC) solution. An illustrative example of an MPU 37 is the commercially available integrated circuit device RF430F5978 from Texas Instruments, Incorporated, which includes an RF transceiver block and a mixed signal processor core on a single integrated circuit. A battery 35 is coupled to a power management block such as a voltage regulator 31 and this provides power Vdd to the MPU 37. Antenna 33 is coupled to MPU 37 for RF transmission. In an example application, the system 30 can be used to implement an asset tracking tag such as an RFID tag, for example.

FIG. 2 provides a simple block diagram of a battery operated sensor application 30. Sensors S1, S2, and S3 are coupled to input/output ports i/o1, i/o2, i/o3 of the MPU 37. The system 30 may implement a variety of functions. Example applications include an alarm system, a weather or water sensing system, a home lighting control system, a portable transponder for asset tracking, toll-tags, or the like. Sensors S1, S2, and S3 can sense temperature, humidity, motion, barometric pressure, wind speed, light, position and the like. The system 30 can communicate with a user computer via the antenna 33 which may be an RF, Bluetooth, or other wireless communications antenna. When an event is sensed by a sensor S1, S2, S3, the system 30 can report the event to a user computer, cell-phone, or tablet. In other applications such as a home lighting control system, the system 30 can receive instructions over the antenna 33 from a user computer. In a home alarm application the sensors may be door or window open sensors, glass breakage sensors, and the like. In another application, a low frequency transponder circuit may be included in device 37 and a low power portable sensor may be implemented that wakes and activates when placed near a low frequency polling device. A wide variety of applications can be supported using such a system. For the personalization of the application, a user can create proprietary microcode for the MPU 37 to control the specific operations of the system. In order to protect the proprietary micro-code from being copied or stolen by an attacker who tries to read the microcode stored in a non-volatile memory, the micro-code can be stored as data in encrypted form. Such a system may use a secret key for encryption and decryption and may be the subject of a side channel attack.

The purpose of a side channel attack is to enable the attacker to obtain the secret key. Side-channel analysis attacks make use of unintended information exposed by the implementation of a cryptographic algorithm. Side-channel information may be any physical property that the attacker can measure, and which is dependent on the cryptographic secret (the key) as well as known data. The side channel information obtained by the attacker helps reduce the search space (the number of possible values) for a given key by correlating the measured physical phenomena with pre-computed hypothetical values. Reducing the search space needed to obtain the key enables an attacker to break the security of an otherwise secure algorithm. If the attacker knows the encryption algorithm being used, and if the attacker gains the value of the secret key, the attacker can then obtain encrypted data from other secure devices using the same secret key and then easily obtain the plaintext data from the stored ciphertext. If the secure devices are chip and PIN credit cards, for example, the successful side channel attacker could feasibly access banking information or other account information that is stored in encrypted form without the PIN code or other similar security codes, and breach the system.

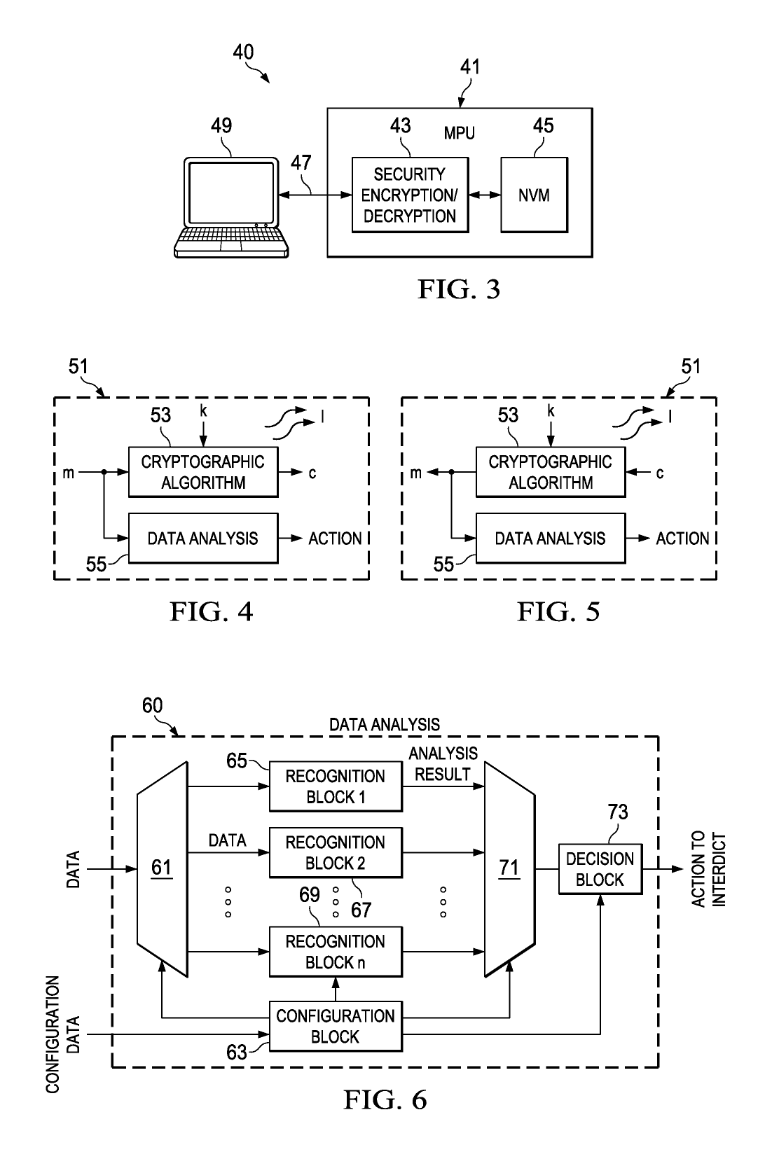

FIG. 3 depicts in a simple illustration an environment for use of the embodiments in a microcode development system 40. In FIG. 3, an MPU device 41 is coupled to a user computer 45 by an interface bus 47. In this environment the user can provide executable instructions in the form of microcode for uploading into the MPU 41, and the MPU 41 can encrypt the microcode before storing it into the NVM 45 by using the encryption scheme in the Security Encryption/Decryption block 43. The user can then try different microcode instructions in this development environment 40 until the microcode is properly running for a particular application. The user can then use this same microcode to manufacture the systems for production. In a production environment, the MPUs 41 would be programmed at a user manufacturing site. The microcode for each completed system would be uploaded into the MPU 41 and stored in encrypted form.

User microcode developed for programmable devices such as MPU 41 is critical to the product differentiation and is also critical for proper operation of the system in the application. Further, the microcode should not be able to be tampered with by an attacker which could cause the application to malfunction or to further expose user information such as account numbers, addresses, identification codes and the like that are stored with the microcode. In system 40, the MPU 41 includes a security encryption and decryption block 43 coupled to non-volatile memory 45. As described above the security encryption and decryption block 43 can perform any block cipher algorithm, including but not limited to one of several known encryption schemes and generate corresponding ciphertext. In aspects of the present application, the countermeasures described in detail below can be added to any implementation of a block cipher algorithm, whether existing, or ones yet to be developed.

For example, the encryption algorithm may be DES, Triple DES, AES, or other encryption schemes that are performed using a stored secret key to encrypt the microcode received from the user development computer 49 prior to storing the microcode in non-volatile memory 45. The encrypted microcode can later be decrypted for use by the MPU 41.

FIG. 4 illustrates in a block diagram an embodiment of a security encryption/decryption module 51 which can be used, for example, as an implementation of module 41 in FIG. 3, with a secure device or system. In FIG. 4, module 51 has two blocks 53, 55 operating independently. Note that the two blocks 53 and 55 need not be implemented as a single module 51, as in this particular example, but can also be, in additional alternative embodiments that are further contemplated as aspects of this application, implemented as stand-alone separate modules. The cryptographic algorithm block 53, which can execute any chosen one of several known encryption schemes such as DES, Triple DES, AES, and the like, is shown in FIG. 4 receiving plaintext data ‘m’ for encryption. A secure encryption key ‘k’ is input into the cryptographic algorithm. The cryptographic algorithm outputs ciphertext ‘c’ for storage as encrypted data. In a microcode application, the plaintext data ‘m’ can include executable machine instructions with opcodes such as add, subtract, shift, store, write register, read register, and the like. The leakage information “l” shown in FIGS. 4 and 5 is the power, electromagnetic emissions, noise, time, current, or other physical information that occurs while the cryptographic algorithm is being performed. The leakage information “l” is the side channel information that an attacker in a side channel attack collects in an attempt to determine the value of the secret encryption key “k”.

In FIG. 4 the novel embodiment shown as module 51 includes a plaintext data analysis block 55. The encryption performed by block 55 and the analysis performed by data analysis block 55 are independent operations and each can be implemented in software, in hardware, or a combination of both. When plaintext data ‘m’ is input to the cryptographic algorithm block 53 during encryption, the data analysis block 55 performs an independent data analysis to determine whether the plaintext data ‘m’ is likely to be within an set of expected plaintext data. If it is likely the data is the result of a side channel attack, and if the plaintext data is not highly correlated to expected data in a particular application, the data analysis block 55 can output a signal that can be used to take an action to prevent or interdict a side channel attack. In order to protect against the loss of the secret key to the attacker, the action should take place before the attacker can completely infer the secret key. Examples of actions that may be taken include halting the encryption process, interrupting or signaling the system, resetting the system, temporarily halting the encryption process and then restarting at a later time, or a combination of these actions.

FIG. 5 depicts the module 51 in a decryption operation. In FIG. 5, ciphertext “c” is input into the cryptographic algorithm block 53 and plaintext data ‘m’ is output. The decryption algorithm reverses the prior encryption process and the secret key ‘k’ is again used. The data analysis block 55 again determines whether the plaintext data ‘m’ corresponds to a set of expected plaintext data. If it appears more likely that the plaintext data output by the decryption is the result of a side channel attack than it is likely to be expected plaintext data, a side channel attack is detected. In this case an action is again taken to prevent or interdict the side channel attack.

The cryptographic algorithm block 53 of FIGS. 4 and 5 can be implemented in software, hardware, or firmware, as micro-code or other instructions for a programmable device or processor, or as dedicated hardware such as a state machine, look up table, RISC processor and the like. ASICs, FPGAs, CPLDs, and other design modules such as design cores or design library cells in an ASIC or CPLD design library can be used to form the encryption and decryption module including the cryptographic algorithm. Similarly, the data analysis block 55 of FIGS. 4 and 5 can be implemented in software, hardware, or firmware, as micro-code or other instructions for a programmable device or processor, or as dedicated hardware such as a state machine, look up table, and the like.

FIG. 6 depicts in a simplified block diagram an example and illustrative implementation of the data analysis block 55 shown in FIGS. 4 and 5. In FIG. 6, a data analysis block 60 is shown with a demultiplexer 61 coupled to receive the plaintext data as an input and outputting the plaintext data to one of “n” recognition blocks 65, 67, 69. Each data recognition performed in the blocks 65, 67, 69 can implement a different type of data analysis. In one recognition block that can be used to form an embodiment, a deterministic approach is used. For example, if the plaintext data corresponds to a certain data set, a stored expected data set is matched against the incoming plaintext data to determine how many pieces of plaintext data in a sample match the expected data, and if the match is highly correlated, the plaintext data is then determined to be valid. If the comparison instead indicates no match or that a poorly correlated comparison exists between the incoming plaintext data and the expected data set, an analysis result can be output that indicates a side channel attack is likely taking place.

Another type of recognition block such as 65, 67, 69 that forms additional alternative embodiments can implement a statistical data analysis. In this approach, a statistical analysis of the incoming plaintext data is performed. In a non-limiting example, the statistical analysis is compared to statistical results previously obtained for known valid plaintext data. For example, the frequency of occurrence of certain characters in a sample of plaintext data can be used. If the statistical analysis indicates it is highly probable that the plaintext data is valid, because the statistical analysis on the incoming samples is highly correlated to the same statistical analysis on a set of expected plaintext data, the statistical analysis result indicates valid data is present. In contrast, if the statistical analysis indicates the sampled plaintext data is very unlikely to be valid data, because the statistical analysis on the sample is very different from the results of the statistical analysis on a set of expected plaintext data, then the analysis result can indicate a side channel attack is likely taking place, and an action should therefore be taken. Predetermined thresholds can be used to process the analysis results.

While the illustrative example data analysis block 60 in FIG. 6 indicates that there may be “n” recognition blocks, in a particular example, a single recognition block can be used. Alternatively, two, three or more recognition blocks can be used. A configuration data input to the configuration block 63 selects which of the possible recognition blocks is active at a particular time. Configuration block 63 then controls the demultiplexer 61, recognition blocks 65, 67, 69, and the data that multiplexer 71 outputs to the decision block 73, and thus the configuration data controls which recognition block is active at a given time. In this manner, in a single system, the encryption detection block such as the cryptographic algorithm 53 in FIGS. 4 and 5 above can be configured to perform plaintext analysis for different data to be encrypted. The plaintext data analysis block 60 can be used to perform the data analysis for the various types of plaintext data that area being encrypted. For example, in a system that processes packet data used over a communications interface, data packets for transmission could be encrypted including a protocol header field. In another process, the same cryptographic algorithm could be used to encrypt microcode for storage in non-volatile memory, as described above. The configuration data and the configuration block 63 make it possible for the data analysis module 60 to operate on different sets of expected plaintext data, using different recognition blocks, as shown.

Decision block 73 receives the analysis result from the currently selected recognition block 65, 67, 69 through multiplexer 71. The decision block 73 is also configured to take an appropriate action for different cases. Actions can include resetting the system, halting the encryption or decryption algorithm, temporarily halting the cryptographic algorithm processes, signaling detection of the side channel attack to the system, interrupting the system or a processor, or combinations of these actions.

The data analysis module 60 of FIG. 6 can be implemented in any combination of hardware, software, firmware and combinations of these approaches. These various implementations form alternative embodiments that are also contemplated by the inventors and which are encompassed by the appended claims. For example, the decision block 73 can be implemented as program instructions for a processor or microprocessor. In an alternative approach a state machine dedicated to implementing the decision block 73 can be used. In still another approach, a look up table could be used to implement the decision block 73. Various combinations of hardware and software can be used. Field programmable devices such as FPGAs, complex logic programmable devices such as CPLDs, application specific integrated circuits such as ASICs, various microcontrollers and programmable controllers, all could be used as implementations of the various blocks in module 60.

FIG. 7 depicts in a sample flow diagram, an embodiment method for performing the plaintext analysis to prevent a side channel attack. In FIG. 7, the method begins at state 81, “Start”. The method continues when the plaintext data is received in state 85, “Receive plaintext”. In state 87, “Perform selected Analysis using a Recognition block”, a data analysis in a selected recognition block is performed. The recognition block compares the plaintext data to a set of expected plaintext data. In state 89, “Results indicate Attack?” the analysis results are tested. If the analysis results indicate the received plaintext data correlates to a set of expected plaintext data, the method transitions to an “End” state 93. If instead, the results indicate the received plaintext data is highly unlikely to be within a set of expected plaintext data, the method transitions to state 91, “Take action to interdict”, and an action is taken to interdict a side channel attack. After the action is taken, the method again transitions to End state, 93.

As described above, the recognition blocks performed in state 87 can perform deterministic analysis, statistical analysis or other analysis on the plaintext data. The recognition blocks used can be a single recognition block, or in some embodiments, several or even many recognition blocks can be used. The recognition blocks in a single method can be tailored to different forms of plaintext used in a particular application, for example, micro-code, and data packet headers, may be received at different times in the same application, and the security encryption/decryption, and the plaintext analysis, are then performed on both types of the plaintext data received.

Use of the various embodiments provides several advantages over the known prior solutions. The plaintext analysis performed in the embodiments is independent of and orthogonal to the encryption and decryption algorithm. The novel plaintext analysis extends the responses to side channel attacks known in the prior art, and the novel features of the embodiments can be added to an existing system without the need to modify the existing algorithms used, and may be added to any new system that performs cryptographic analysis without disturbing the encryption and decryption systems. The side channel attack prevention is achieved using the embodiments without the prior known solution such as slowing down the encryption and decryption with random data or with random operations that create additional inefficiencies in the algorithms. The plaintext analysis can be tailored for a variety of data types that will be encrypted in a particular system by creating a variety of recognition blocks. A side channel attack detected using the embodiments may be interdicted or prevented without the need for adding electromagnetic shielding or the need for other physical shields to the system.

The cryptographic algorithms and plaintext data analysis modules of the various embodiments can be provided as a set of non-transitory executable instructions stored in a computer readable tangible media. For example, computer readable media can include CDs, DVDs, diskettes, floppy disks, compact memory cards, memory sticks, FLASH memory devices such as USB drives, and the like. Further the set of non-transitory executable instructions can be stored at an accessible data storage such as a web server that can be accessed by a system for download.

Although the example embodiments have been described in detail, it should be understood that various changes, substitutions and alterations can be made herein without departing from the spirit and scope of the application as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

What is claimed is:

1. A system including countermeasures for side channel attacks, comprising:
an encryption/decryption module coupled to receive plaintext data for encryption and outputting corresponding ciphertext, and further coupled to receive ciphertext for decryption and outputting corresponding plaintext data, the encryption/decryption module performing an encryption algorithm using a secure encryption key stored in non-volatile memory, the encryption/decryption module further performing an algorithm for decrypting encrypted ciphertext using the secure encryption key; and
a plaintext analysis module coupled to the plaintext data received by the encryption/decryption module for encryption and further coupled to the plaintext data output from the encryption/decryption module after decryption, the plaintext analysis module performing an analysis on the plaintext data and determining whether the plaintext data correlates to expected plaintext data, the plaintext analysis module further having an output for outputting a signal indicating a side channel attack, responsive to the determining.

2. The system of claim 1, wherein the plaintext analysis module further comprises:
a plurality of recognition blocks each coupled to selectively receive the plaintext data and each performing a different plaintext analysis to determine whether the plaintext data is within an expected plaintext data set, and each having an output for outputting an analysis result signal responsive to the determining; and
a decision block coupled to receive the analysis result signal from a selected one of the plurality of recognition blocks, and having outputs for outputting one or more action signals responsive to the received analysis result.

3. The system of claim 2, wherein at least one of the plurality of recognition blocks performs a statistical analysis on the plaintext data.

4. The system of claim 3 wherein the at least one of the plurality of recognition blocks performs the statistical analysis on the plaintext data by generating a probability factor indicating the probability that a pattern in a sample of the plaintext data correlates to an expected data pattern, and if the probability factor is below a predetermined threshold, the at least one recognition block outputs a result analysis signal indicating a side channel attack.

5. The system of claim 2, wherein at least one of the plurality of recognition blocks performs a deterministic analysis on the plaintext data.

6. The system of claim 5, wherein the at least one of the plurality of recognition blocks performs a comparison between a selected number of samples of plaintext data and an expected plaintext data pattern, and if the comparison indicates that a number of matches between the sampled plaintext data and the expected data pattern is below a predetermined threshold, the at least one recognition block outputs a result analysis signal indicating a side channel attack.

7. The system of claim 2, wherein the action signal output by the decision block in response to a result analysis from a selected one of the recognition blocks indicating a side channel attack is one selected from the group consisting essentially of a reset signal, a halt signal, an interrupt signal, and a wait signal.

8. The system of claim 2, wherein the action signal output by the decision block in response to a result analysis from a selected one of the recognition blocks indicating a side channel attack is a halt signal.

9. The system of claim 1, wherein the plaintext data corresponds to micro-code for a programmable processor.

10. The system of claim 1, wherein the plaintext data corresponds to packet data protocol headers for data packets.

11. A method for providing side channel attack countermeasures, comprising:
in a secure encryption/decryption module, performing data encryption on plaintext data using a stored secure encryption key and outputting ciphertext corresponding to the plaintext data, and further performing a data decryption on ciphertext using the stored secure encryption key, and outputting plaintext data corresponding to the ciphertext;
performing analysis on the plaintext data in a plaintext data analysis module coupled to receive the plaintext data and determining whether the plaintext data corresponds to plaintext data within an expected plaintext data set; and
performing an action to interdict a side channel attack responsive to the determining.

12. The method of claim 11, wherein performing analysis on the plaintext data in the plaintext data module further comprises:
receiving configuration control signals to select one of a plurality of plaintext data recognition blocks, each of the plurality of plaintext recognition blocks configured to perform a different data analysis on the plaintext data;
in the selected one of the plaintext data recognition blocks, performing an analysis on a sample of the plaintext data, and outputting an analysis result signal; and
receiving the analysis result signal in a decision block and performing a predetermined action in the decision block responsive to the analysis result signal.

13. The method of claim 12, wherein at least one of the plurality of plaintext data recognition blocks performs a deterministic analysis on the plaintext data.

14. The method of claim 12, wherein at least one of the plurality of plaintext data recognition blocks performs a statistical analysis on the plaintext data.

15. The method of claim 12, wherein performing the action further comprises halting the encryption/decryption module.

16. The method of claim 12, wherein performing the action further comprises resetting the encryption/decryption module.

17. The method of claim 12, wherein performing the action further comprises signaling a side channel attack has been detected to a system.

18. A tangible non-volatile computer readable media storing non-transitory instructions for a processor which, when retrieved and executed by the processor, cause the processor to perform:
encrypting received plaintext data into ciphertext by performing an encryption algorithm and using a secure encryption key stored in a non-volatile memory; and
performing a plaintext analysis to determine whether the plaintext data corresponds to a set of expected plaintext data, and signaling a side channel attack is detected, responsive to the determining.

19. The tangible non-volatile computer readable media of claim 18, and further comprising additional stored executable instructions for the processor which, when retrieved and executed by the processor, cause the processor to perform:
receiving configuration control signals to select one of a plurality of plaintext data recognition blocks, each of the plurality of plaintext recognition blocks configured to perform a different analysis on the plaintext data;
in the selected one of the plaintext data recognition blocks, performing an analysis on a sample of the plaintext data, and outputting an analysis result signal; and
performing a predetermined action in a decision block to interdict a side channel attack, responsive to the analysis result signal.

20. The tangible non-volatile computer readable media of claim 18, and further comprising additional stored executable instructions for the processor which, when retrieved and executed by the processor, cause the processor to perform:
retrieving stored ciphertext from a memory device;
performing a decryption algorithm on the retrieved stored ciphertext using the secure encryption key stored in a non-volatile memory, and outputting plaintext data corresponding to the ciphertext; and
performing a plaintext data analysis to determine whether the plaintext data corresponds to a set of expected plaintext data, and signaling a side channel attack responsive to the determining.
